(19) United States
(12) Patent Application Publication
(10) Pub. No.: US 2026/0042256 A1
(43) Pub. Date: Feb. 12, 2026

(54) DUAL PRINTING HEAD DEVICE WITH TENSIONING DEVICE FOR CONTINUOUS FIBER-REINFORCED COMPOSITES

(71) Applicant: NANJING UNIVERSITY OF AERONAUTICS AND ASTRONAUTICS, Nanjing (CN)

(72) Inventors: Wenzhe SONG, Nanjing (CN); Zhongde SHAN, Nanjing (CN); Congze FAN, Nanjing (CN); Yiwei CHEN, Nanjing (CN); Jinghua ZHENG, Nanjing (CN); Yaxing SONG, Nanjing (CN)

(73) Assignee: NANJING UNIVERSITY OF AERONAUTICS AND ASTRONAUTICS, Nanjing (CN)

(21) Appl. No.: 19/365,213

(22) Filed: Oct. 22, 2025

Related U.S. Application Data
(63) Continuation of application No. PCT/CN2025/071952, filed on Jan. 13, 2025.

(30) Foreign Application Priority Data
Aug. 8, 2024 (CN) 202411085437.X

(51) Int. Cl. B29C 64/209; B29C 64/295; B29C 64/336; B33Y 30/00

(52) U.S. Cl. CPC B29C 64/209; B29C 64/295; B29C 64/336; B33Y 30/00

(57) ABSTRACT

A dual printing head device with a tensioning device for continuous fiber-reinforced composites includes a printing support frame; a continuous fiber printing mechanism is provided on the printing support frame, and a filament extrusion mechanism is provided next to the continuous fiber printing mechanism; the filament extrusion mechanism is connected to the printing support frame through a dual nozzle switching mechanism; a fiber guide block is provided below the continuous fiber printing mechanism; a speed feedback follower wheel is provided next to the fiber guide block; the speed feedback follower wheel is connected to a filament feeding fiber force control encoder; and the dual nozzle switching mechanism includes a horizontal guide rail, a push plate mounting plate, a positioning guide groove, a filament fixing plate, and a rear mounting plate. The dual printing head device achieves free switching between dual heads during printing, ensuring the stability of feeding continuous fibers.

### CROSS REFERENCE TO THE RELATED APPLICATIONS

This application is a continuation application of International Application No. PCT/CN2025/071952, filed on Jan. 13, 2025, which is based upon and claims priority to Chinese Patent Application No. 202411085437.X, filed on Aug. 8, 2024, the entire contents of which are incorporated herein by reference.

### TECHNICAL FIELD

The present invention relates to a 3D printing device, and in particular, to a dual printing head device with a tensioning device for continuous fiber-reinforced composites.

### BACKGROUND

3D printing for continuous fiber-reinforced composites is a novel additive manufacturing technology, which involves melting and extruding continuous fiber pre-impregnated filaments inside a 3D printing nozzle and stacking the filaments layer by layer with the movement of the nozzle to form a one-piece structure. “Dual nozzle switching devices” in existing commercial continuous fiber printers are mainly used to solve the problems of low material switching speed and low accuracy that are prone to occur in single nozzle printing. Existing switching devices often utilize belts or sliders to switch printing materials through synchronous reverse movement of up and down positions of two printing heads. This scheme is not conducive to long-term printing and frequent switching between printing heads, and cannot guarantee the reliability of relative position accuracy of the two printing heads after switching.

In addition, the tension of continuous fibers in printing due to the mismatch between feeding speed and moving speed is an important factor that leads to fiber damage to affect printing quality. Current printer speed control only relies on preset speed information and cannot make corresponding adjustments to the actual printing situation, which is a key limitation that limits the stable printing and forming of large-breadth continuous fiber members.

### SUMMARY

To solve the above problems, the present invention discloses a dual printing head device with a tensioning device for continuous fiber-reinforced composites, which can achieve free switching between dual heads during printing. Meanwhile, a continuous fiber printing head employs a floating extruder, which relies on a rotary encoder lag following control method to solve the problem of inaccurate fiber conveying quantity in existing printing heads.

A dual printing head device with a tensioning device for continuous fiber-reinforced composites includes a printing support frame; a continuous fiber printing mechanism is provided on the printing support frame, and a filament extrusion mechanism is provided next to the continuous fiber printing mechanism; the filament extrusion mechanism is connected to the printing support frame through a dual nozzle switching mechanism; a fiber guide block is provided below the continuous fiber printing mechanism, and a speed feedback follower wheel is provided next to the fiber guide block; the speed feedback follower wheel is connected to a filament feeding fiber force control encoder; the dual nozzle switching mechanism includes a horizontal guide rail, a push plate mounting plate, a positioning guide groove, a filament fixing plate, and a rear mounting plate; the filament extrusion mechanism is fixed on the filament fixing plate; a side of the filament fixing plate is slidably connected to the rear mounting plate, and a top of the filament fixing plate is provided with a positioning guide groove; the push plate mounting plate is slidably arranged on the horizontal guide rail; and the positioning guide groove is inclined and provided with positioning engagement points at both ends that are adapted to the follower roller.

Further, one end of the rear mounting plate is provided with a dual head switching reset auxiliary mechanism; the dual head switching reset auxiliary mechanism includes a column, a reset spring, and a pressure block; one end of the filament fixing plate extends with the pressure block; the pressure block is provided with a through hole allowing the column to pass through; the spring I is located at a bottom of the pressure block and fitted onto the column I; and the column is welded and fixed to the rear mounting plate.

Further, a multi-channel water cooling module and a heating module are sequentially provided under discharge ends of the continuous fiber printing mechanism and the filament extrusion mechanism.

Further, the water cooling module is provided with a water cooling quick connector and a water cooling plug.

Further, an air cooling module is mounted on the multi-channel water cooling module; the air cooling module includes an air cooling bracket and a turbofan; and the turbofan is fixed on the air cooling bracket.

Further, a fiber force control mechanism is provided at each of two ends of the continuous fiber printing mechanism, where the fiber force control mechanism includes a force control fixing block; a column II in sliding fit with the force control fixing block is provided on the printing support frame; and each column II is fitted with a spring II.

Further, a driving motor drives a filament feeding wheel in the filament extrusion mechanism to rotate.

The working principle of the present invention is as follows:

By providing the encoder in the present invention, the laying speed of the driving motor can be ensured in a timely manner, the tension that occurs in the filament feeding process is effectively alleviated, and stability in a filament feeding state is achieved. Meanwhile, by using the dual nozzle switching mechanism for switching, during movement of the printing head, the push rod touches a limit rod on the device. During pushing, the push plate mounting plate slides transversely on the horizontal guide rail, thereby driving the follower roller to slide along the positioning guide groove, driving the switching of up and down positions of the filament extrusion mechanism, and ensuring the switching of the continuous filament printing mechanism at any time during printing without interference. During switching, the coordination between the column I and the reset spring I ensures the smoothness of up and down movement of the extrusion mechanism;

By designing the fiber force control mechanism in the present invention, when the continuous fiber printing mechanism receives printing code information, the driving motor drives the filament feeding wheel in the continuous fiber printing mechanism to rotate according to a filament feeding speed in the printing information, thereby achieving initial feeding of a continuous fiber. At this moment, the continuous fiber drives the speed feedback follower wheel, and the filament feeding fiber force control encoder acquires an actual feeding speed of the continuous fiber through the speed feedback follower wheel, and takes over the control on the filament feeding speed of the driving motor. When the movement speed of the continuous fiber printing mechanism does not match the filament feeding speed during printing, the continuous fiber will be tensioned and pulls down relevant parts of the driving motor, while the allowable tensioning spring II of the fiber force control mechanism releases the tension by deformation to temporarily relieve the damage of sudden pulling to the fiber. Synchronously, the filament feeding fiber force control encoder detects the actual filament feeding speed slowed down due to fiber pulling, and controls the driving motor to accelerate for re-matching the filament feeding speed and the movement speed.

Beneficial effects of the present invention are as follows:

1. To achieve free switching between dual heads during printing and ensure the stability of feeding a continuous fiber, the mechanical limit triggered dual nozzle switching auxiliary mechanism achieves accurate and smooth switching between dual nozzles in the continuous fiber printing process, thereby effectively avoiding a decrease in printing quality or printing failure due to changes in the relative positions of the dual nozzles.

2. The feeding auxiliary mechanism based on active detection of an actual filament feeding speed achieves a continuous and stable feeding state in the continuous fiber printing process, thereby effectively suppressing fiber tension caused by mismatch between a filament feeding speed and a movement speed.

### BRIEF DESCRIPTION OF THE DRAWINGS

FIG. 1 is a schematic structural diagram of the present invention;

FIG. 2 is a rear view of FIG. 1; and

FIG. 3 is an enlarged view of a continuous fiber printing mechanism and a filament extrusion mechanism in a coordination state.

### REFERENCE NUMERALS

1—printing support frame; 2—dual nozzle switching mechanism; 3—filament extrusion mechanism; 4—air cooling module; 5—continuous fiber printing mechanism; 9—heating module; 8—driving motor; 7—multi-channel water cooling module; 71—water cooling quick connector; 72 water cooling plug; 41—turbofan; 42—air cooling bracket; 21—horizontal guide rail; 22—push plate mounting plate, 23—positioning guide groove, 25—filament fixing plate, 26—rear mounting plate; 27—follower roller; 28—push rod; 241—column, 242—spring; 243—pressure block; 52—fiber guide block; 53—speed feedback follower wheel; 54—filament feeding fiber force control encoder; 55—force control fixing block; 56—column II; 57—spring II.

### DETAILED DESCRIPTION OF THE EMBODIMENTS

The present invention will be further illustrated below in conjunction with the accompanying drawings and specific embodiments. It should be understood that the following specific embodiments are merely used for explaining the present invention, rather than limiting the scope of the present invention. It should be noted that the terms “front”, “back”, “left”, “right”, “upper”, and “lower” used in the following description refer to the directions in the accompanying drawings, and the terms “inside” and “outside” refer to the directions towards or away from the geometric center of a specific component respectively.

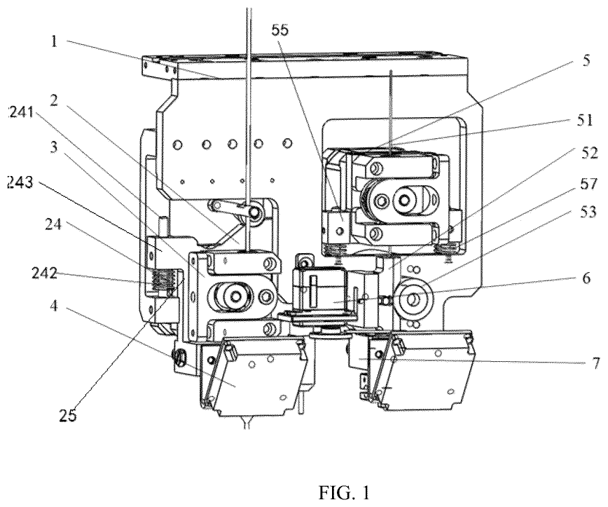

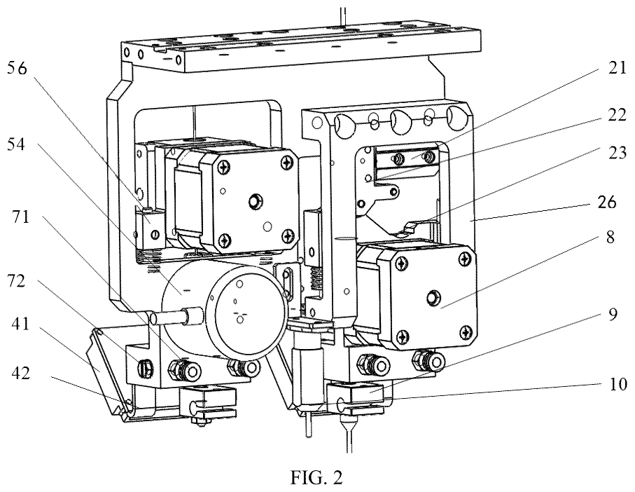

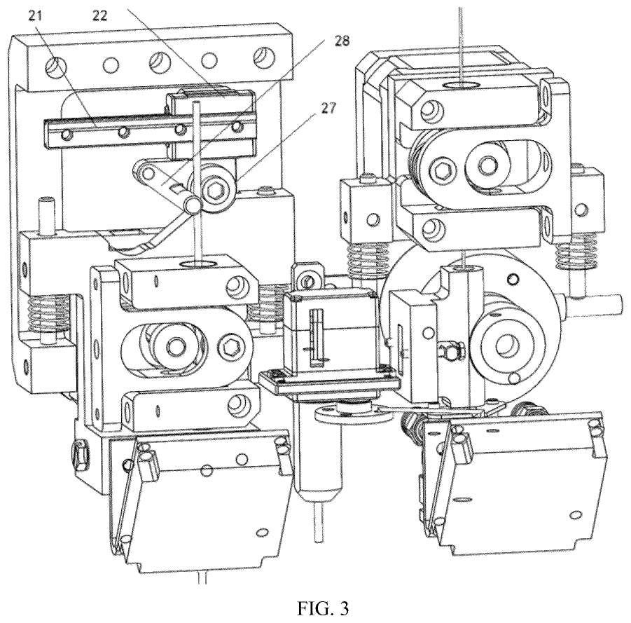

As shown in FIGS. 1-3, a dual printing head device with a tensioning device for continuous fiber-reinforced composites in this embodiment includes a printing support frame 1; an automatic leveling module 10 is provided at a bottom of the printing support frame 1; a continuous fiber printing mechanism 5 is provided on the printing support frame 1, and a filament extrusion mechanism 3 is provided next to the continuous fiber printing mechanism 5, where the filament extrusion mechanism 3 is connected to the printing support frame 1 through a dual nozzle switching mechanism 2.

A multi-channel water cooling module 7 and a heating module 9 are sequentially provided under discharge ends of the continuous fiber printing mechanism 5 and the filament extrusion mechanism 3; and the water cooling module 7 is provided with a water cooling quick connector 71 and a water cooling plug 72. An air cooling module 4 is mounted on the multi-channel water cooling module 7; and the air cooling module 4 includes an air cooling bracket 42 and a turbofan 41, where the turbofan 41 is fixed on the air cooling bracket 42.

The dual nozzle switching mechanism 2 includes a horizontal guide rail 21, a push plate mounting plate 22, a positioning guide groove 23, a filament fixing plate 25, and a rear mounting plate 26; the filament extrusion mechanism 3 is fixed on the filament fixing plate 25; a side of the filament fixing plate 25 is slidably connected to the rear mounting plate 26, and a top of the filament fixing plate 25 is provided with the positioning guide groove 23; the push plate mounting plate 22 is slidably arranged on the horizontal guide rail 21; a bottom of the push plate mounting plate 22 is in sliding fit with the positioning guide groove 23 through a follower roller 27; the positioning guide groove 23 is inclined and provided with positioning engagement points at both ends that are adapted to the follower roller 27; and a push rod 28 is provided at an end, away from the follower roller 27, of the push plate mounting plate 22.

One end of the rear mounting plate 26 is provided with a dual head switching reset auxiliary mechanism 24; the dual head switching reset auxiliary mechanism 24 includes a column 241, a spring 242, and a pressure block 243; one end of the filament fixing plate 25 extends with the pressure block 243; the pressure block 243 is provided with a through hole allowing the column 241 to pass through; the spring I 242 is located at a bottom of the pressure block 243 and fitted onto the column I 241; and the column 241 is welded and fixed to the rear mounting plate 26.

This embodiment utilizes the dual nozzle switching mechanism for switching. During movement of a printing head, the push rod touches a limit rod on the device. During pushing, the push plate mounting plate 22 slides transversely on the horizontal guide rail 21, thereby driving the follower roller 27 to slide along the positioning guide groove 23, driving the switching of up and down positions of the filament extrusion mechanism 3, and ensuring the switching of the continuous filament printing mechanism at any time during printing without interference. During switching, the coordination between the column I 241 and the reset spring I 242 ensures the smoothness of up and down movement of the extrusion mechanism.

The continuous fiber printing mechanism 5 is provided on the printing support frame 1, and the filament extrusion mechanism 3 is provided next to the continuous fiber printing mechanism 5; the filament extrusion mechanism 3 is connected to the printing support frame 1 through the dual nozzle switching mechanism 2; a fiber guide block 52 is provided below the continuous fiber printing mechanism 5; a speed feedback follower wheel 53 is provided next to the fiber guide block 52; the speed feedback follower wheel 53 is connected to a filament feeding fiber force control encoder 54; and a driving motor 8 drives a filament feeding wheel in the continuous fiber printing mechanism 5 to rotate. A fiber force control mechanism is provided at each of two ends of the continuous fiber printing mechanism 5, where the fiber force control mechanism includes a force control fixing block 55; a column II 56 in sliding fit with the force control fixing block 55 is provided on the printing support frame 1; and each column II 56 is fitted with a spring II 57.

By designing the fiber force control mechanism in this embodiment, when the continuous fiber printing mechanism 5 receives printing code information, the driving motor 8 drives the filament feeding wheel in the continuous fiber printing mechanism 5 to rotate according to a filament feeding speed in the printing information, thereby achieving initial feeding of a continuous fiber. At this moment, the continuous fiber drives the speed feedback follower wheel, and the filament feeding fiber force control encoder 54 acquires an actual feeding speed of the continuous fiber through the speed feedback follower wheel 53, and takes over the control on the filament feeding speed of the driving motor 8. When the movement speed of the continuous fiber printing mechanism does not match the filament feeding speed during printing, the continuous fiber will be tensioned and pulls down relevant parts of the driving motor 8, while the allowable tensioning spring II 57 of the fiber force control mechanism releases the tension by deformation to temporarily relieve the damage of sudden pulling to the fiber. Synchronously, the filament feeding fiber force control encoder detects the actual filament feeding speed slowed down due to fiber pulling, and controls the driving motor to accelerate for re-matching the filament feeding speed and the movement speed.

A specific control method includes the following steps:
Step 1: The left printing head is a short fiber printing head, the right printing head is a continuous fiber printing head, and a position sensor is mounted at a fixed position relative to the left printing head. When the printer returns to zero in a Z direction, the position sensor determines a position of the left printing head relative to a printing platform. Meanwhile, the relative positions of the right printing head and the left printing head are fixed before and after the switching of the switching device. Therefore, using one position sensor can simultaneously determine the positions of the left printing head and the right printing head relative to the printing platform;
Step 2: Collaborative printing of a short fiber and a continuous fiber is implemented, that is, in the process of printing one component, the left printing head and the right printing head work alternately and collaboratively. Herein, the left printing head first prints as an example. When the left printing head is in an active state, the right printing head is in a waiting state, and the left printing head starts printing. When the left printing head completes printing and needs to be switched to the right printing head, the left printing head moves along a specified printing head switching movement path to a printing head switching starting position slowly from left to right. In the process of moving to a printing head switching ending position, a printing head lever hits a collision rod fixed on the printer. In this process, the lever carries the follower wheel at the end of the lever to move along a lever fixing slide rail. Under the action of positioning tensioning spring force of the printing head, when the lever and the follower wheel move to the left, the left printing head starts rising until the printing head moves to the printing head switching ending position, and the left printing head rises to a highest point under the constraints of the follower wheel and a follower wheel limit slide, to complete switching from the left head to the right head.
Step 3: At this time, the right head is in an active state and starts printing. A 3D printer control motherboard sends drive signals to control a step motor driver of a right head extruder. The step motor driver controls an extruder step motor to transport the continuous fiber of a target length downwards;
Step 4: The continuous fiber filament is tangent to the feedback follower wheel of the rotary encoder. When the extruder transports the continuous fiber downwards, the follower wheel of the rotary encoder rotates counterclockwise due to the tension of the mechanism and the frictional force of the continuous fiber filament;
Step 5: The rotary encoder provides real-time feedback on the rotational speed and direction of the follower wheel during rotation. The rotational speed and direction of the follower wheel of the rotary encoder are also the actual feeding speed and direction of the continuous fiber. The rotary encoder outputs this signal to a signal receiving and processing unit of the rotary encoder;
Step 6: The signal receiving and processing unit of the rotary encoder analyzes and processes the real-time feedback of feeding parameter values of the right head extruder motor. After the extruder delivers the continuous fiber filament to the printing nozzle and the filament adheres to the printed body, the 3D printer control motherboard releases the control of the right continuous fiber printing head extruder, and then the right head extrusion step motor driver synchronously switches to receive a control signal from the signal processing unit of the rotary encoder. Afterwards, the right head extrusion step motor controls the feeding speed of the continuous fiber through the signal receiving and processing unit of the rotary encoder;
Step 7: When the 3D printer motherboard and the signal receiving and processing unit of the rotary encoder switch the control on the right head extruder step motor, the right head extruder motor stops rotating, and the printing state continues. At this time, one end of the continuous fiber adheres to a printing surface, the other end of the continuous fiber is supported by the continuous fiber printing head extruder mechanism, and the extruder stops rotating. Therefore, the continuous fiber consumed in the extruder control switching process is dragged by the movement of the printing head, the continuous fiber is dragged by the extruder motor floating on the spring. The length of the spring compressed by the extruder motor provides the continuous fiber consumed in this process. Due to the extremely fast signal switching speed, in the compression process of the tensioning spring, a rotary encoder feedback signal controls the right head extruder step motor driver to control the motor to feed the fiber, and the compressed spring is released and reset;
Step 8: The signal receiving and processing unit of the rotary encoder controls the filament feeding speed of the right head extruder step motor, the actual consumption of the filament, and the compression amount of the tensioning spring to maintain a dynamic balance. That is, when the actual consumption of the filament is greater than the filament feeding length of the extruder controlled by the rotary encoder, the extruder motor compresses the tensioning spring to provide a difference between the actual consumption length and the filament feeding length of the extruder controlled by the signal receiving and processing unit of the rotary encoder. Meanwhile, the rotary encoder obtains the difference to increase a balance difference of the filament feeding speed. Finally, the actual consumption length of the continuous fiber is consistent with the filament feeding length of the extruder motor;
Step 9: After the right continuous fiber printing head completes the printing task, the printing head moves to a left head starting position, and the printing head moves from right to left. In the process of moving to the printing head switching ending position, a printing head lever hits a collision rod fixed on the printer. In this process, the lever carries the follower wheel at the end of the lever to move along the lever fixing slide rail. Under the action of positioning tensioning spring force of the printing head 24, when the lever and the follower wheel move to the left, the left printing head starts falling until the left printing head moves to the printing head switching ending position, the left printing head falls to a lowest point under the constraints of the follower wheel and the follower wheel limit slide, to complete switching from the right head to the left head. The left head is active and starts the printing task;
Step 10: So far, a loop adjustment control ends.

The technical means disclosed in the solutions of the present invention are not limited to the technical means disclosed in the foregoing embodiments, but also include technical solutions formed by any combination of the above technical features.

What is claimed is:

1. A dual printing head device with a tensioning device for continuous fiber-reinforced composites, comprising a printing support frame, wherein a continuous fiber printing mechanism is provided on the printing support frame; a filament extrusion mechanism is provided next to the continuous fiber printing mechanism, and the filament extrusion mechanism is connected to the printing support frame through a dual nozzle switching mechanism; a fiber guide block is provided below the continuous fiber printing mechanism, a speed feedback follower wheel is provided next to the fiber guide block, and the speed feedback follower wheel is connected to a filament feeding fiber force control encoder; the dual nozzle switching mechanism comprises a horizontal guide rail, a push plate mounting plate, a positioning guide groove, a filament fixing plate, and a rear mounting plate; the filament extrusion mechanism is fixed on the filament fixing plate, a side of the filament fixing plate is slidably connected to the rear mounting plate, and a top of the filament fixing plate is provided with the positioning guide groove; the push plate mounting plate is slidably arranged on the horizontal guide rail, and a bottom of the push plate mounting plate is in sliding fit with the positioning guide groove through a follower roller; a push rod is provided at an end, away from the follower roller, of the push plate mounting plate; and the positioning guide groove is inclined and provided with positioning engagement points at both ends, wherein the positioning engagement points are adapted to the follower roller.

2. The dual printing head device with the tensioning device for the continuous fiber-reinforced composites according to claim 1, wherein an end of the rear mounting plate is provided with a dual head switching reset auxiliary mechanism; the dual head switching reset auxiliary mechanism comprises a first column, a reset spring, and a pressure block; a first end of the filament fixing plate extends with the pressure block; the pressure block and a second end of the filament fixing plate are provided with through holes allowing the first column to pass through; the reset spring is fitted onto the first column; and the first column is welded and fixed to the rear mounting plate.

3. The dual printing head device with the tensioning device for the continuous fiber-reinforced composites according to claim 1, wherein a multi-channel water cooling module and a heating module are sequentially provided under discharge ends of the continuous fiber printing mechanism and the filament extrusion mechanism; the multi-channel water cooling module is provided with a water cooling quick connector and a water cooling plug; an air cooling module is mounted on the multi-channel water cooling module; the air cooling module comprises an air cooling bracket and a turbofan; and the turbofan is fixed on the air cooling bracket.

4. The dual printing head device with the tensioning device for the continuous fiber-reinforced composites according to claim 1, wherein a fiber force control mechanism is provided at each of two ends of the continuous fiber printing mechanism, wherein the fiber force control mechanism comprises a force control fixing block; a second column in sliding fit with the force control fixing block is provided on the printing support frame; and the second column is fitted with an allowable tensioning spring.

5. The dual printing head device with the tensioning device for the continuous fiber-reinforced composites according to claim 1, wherein a driving motor drives a filament feeding wheel in the filament extrusion mechanism to rotate.
